(19) United States
(12) Patent Application Publication
(10) Pub. No.: US 2009/0187488 A1
(43) Pub. Date: Jul. 23, 2009

(54) METHOD AND SYSTEM FOR PROVIDING A SERVICE TO A CUSTOMER

(76) Inventor: John Shamilian, Tinton Falls, NJ (US)

Correspondence Address: WALL & TONG, LLP/;ALCATEL-LUCENT USA INC., 595 SHREWSBURY AVENUE, SHREWSBURY, NJ, 07702, US

(21) Appl. No.: 12/017,381

(22) Filed: Jan. 22, 2008

(51) Int. Cl. G06Q 20/00; G06Q 30/00

(52) U.S. Cl. 705/16; 705/1

(57) ABSTRACT

A system and method for providing a service to a customer wherein a transaction engine processes an order placed by a customer for at least one product provided by at least one provider. A location engine provides the customer location information to the provider to enable thereby an adaptation of a provider order fulfillment process.

### FIELD OF THE INVENTION

The invention relates to the field of order fulfillment and, more specifically, to providing synchronized order fulfillment.

### BACKGROUND

Many restaurants now offer a curbside pick-up service to their customers. A customer places an order for food via telephone, facsimile or Internet transaction. In response, the restaurant provides the customer with an approximate pick-up time. The customer drives to the restaurant and parks in a curbside pick-up parking spot. Ideally, as soon as the customer arrives, the restaurant's employee brings the ordered food to the customer's vehicle. The customer pays, takes the food, and leaves. To recognize the customer's arrival, the restaurant's employees monitor the curbside parking area by looking through a window or via closed-circuit cameras.

Whether the customer receives the ordered food upon arrival depends on when the restaurant's employees notice the customer's car and whether the food is ready. The customer's departure with the ordered food may be delayed by a payment transaction wherein an employee first receives a credit card from the customer outside the restaurant, processes the card inside the restaurant, and finally has the customer sign a receipt outside the restaurant. If the customer is delayed ordered food will be waiting for him to arrive, though significant delays in the customer's arrival might cause the food to become cold.

### SUMMARY

Various deficiencies in the prior art are addressed by embodiments of a method and a system for fulfilling a customer order in a timely manner. In one embodiment, a system for providing a service to a customer comprises a transaction engine, for transacting with a customer to receive therefrom an order for at least one product of a provider, and for providing a processed order to the provider; and a location engine, for providing customer location information to enable thereby an adaptation of a provider order fulfillment process.

In another embodiment, a method for providing a service to a customer comprises receiving an order from the customer; initiating an order fulfillment process; receiving customer location information; and adapting the order fulfillment process in response to the customer location information.

In yet another embodiment, a system for providing a service to one or more customers comprises a server-support system and one or more providers in communication with the server-support system, wherein the server-support system provides customer location information to the one or more provider regarding the one or more customers, in response to receiving at least one order for the one or more provider.

### BRIEF DESCRIPTION OF THE DRAWINGS

The teachings of various embodiments can be readily understood by considering the following detailed description in conjunction with the accompanying drawings, in which:

FIG. 1 illustrates a high level diagram of a system for providing a service to a customer according to one embodiment;

FIG. 2 depicts a flow diagram of a method for providing a service to a customer according to one embodiment;

FIG. 3 illustrates a high level diagram of a system for providing a service to one or more customers according to yet another embodiment;

FIG. 4 illustrates a high level block diagram of the method for providing a service to a customer that is implemented using a general purpose computing device.

To facilitate understanding, identical reference numerals have been used, where possible, to designate identical elements that are common to the figures.

### DETAILED DESCRIPTION

Various embodiments will be described herein within the context of a curb-side pickup service associated with, for example, a fast food restaurant. However, the invention is broadly applicable to any situation wherein a customer or other entity is requesting a product or service having associated with it a fulfillment process of finite duration. Thus, while location herein is discussed primarily with respect to a customer driving to a restaurant to pick up food, the “customer” may instead comprise a courier or delivery service. Moreover, rather than food, the fulfillment process may be directed towards the procurement of any types of goods or services. Thus, the invention has broader application within the field of logistics.

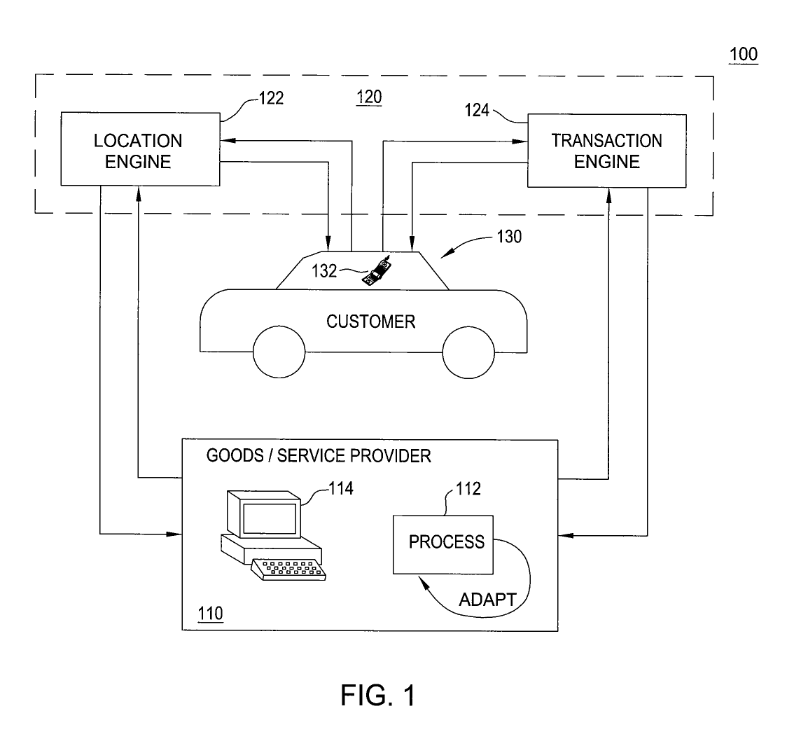

FIG. 1 depicts a high level diagram of a system for providing a service to a customer, according to one embodiment. Specifically, the system 100 of FIG. 1 comprises a provider 110 of goods and/or services and a server-support system 120. A customer 130 places an order for, illustratively, one or more products of the provider 110 via the server-support system 120. The server-support system 120 monitors the customer location and communicates the customer location and/or an estimated time of arrival (ETA) to the provider 110. The customer's order is prepared as part of a fulfillment process 112 while the customer 130 travels to the provider 110. The preparation pace or other fulfillment process parameter(s) is adjusted according to the customer location and/or ETA. Upon the customer's arrival at the provider location, the provider 110 provides the customer 130 with the ordered product(s).

The provider 110 is typically a business providing goods and/or services to the customer 130. For example, the provider 110 can be a restaurant, fast food restaurant, cafe, pizza place, or the like. The provider 110 can also be a grocery, department, apparel, convenience, home furnishing, house and garden, pharmacy, specialty, general merchandise, or the like store. The provider's product include goods (e.g., lumber), services (e.g., changing tires), and/or a combination of the goods and services, (e.g., a t-shirt with custom embroidery selected by the customer). Further, the provider 110 may have one or multiple locations.

The provider 110 has associated with it a terminal 114 (e.g., a personal computer with a web browser), which allows the provider 110 to communicate with the customer 130 via the server-support system 120 and receive information regarding the customer 130. After the provider 110 receives a customer order (e.g., via terminal 114), the fulfillment process 112 is started. To provide the customer 130 with the ordered product on time, the fulfillment process 112 is adapted as necessary in response to information about the customer received at the terminal 114. In the embodiment where the provider 110 has multiple locations, each such location optionally includes a terminal 114. Alternatively, one terminal 114 serves a portion or all of the provider's locations.

The server-support system 120 includes a location engine 122 and a transaction engine 124. While the location engine 122 and the transaction engine 124 are depicted as two distinct modules of the server-support system, in other embodiments they are combined into one module performing functions of both modules. In yet other embodiments, the location engine 122 and the transaction engine 124 are completely separate entities.

Customer 130 has associated with it a communication device 132, which allows the customer to communicate with the provider 110 via the server-support system 120, namely via the transaction engine 124 and/or the location engine 124. In one embodiment, the customer 130 places an order for at least one product of the provider 110 and sends/receives messages to/from the transaction engine 124 of the provider 110 via the communication device 132. In yet another embodiment, the communication device 132 supplies the location engine 122 with the customer location for subsequent transmission of such information to the provider 110.

In the embodiment depicted in FIG. 1, the customer 130 transacts with the provider 110 via a single communication device 132 having GPS and/or broadband capabilities such as a personal digital assistant (PDA), a mobile phone (such as a smart phone), a navigation system with broadband capabilities, a notebook computer with GPS capabilities, and the like.

However, in another embodiment, the customer 132 optionally uses separate communication devices to place an order, to communicate with the provider, and/or to provide his/her location. Thus, a communication device without GPS and/or broadband capabilities may be used, such as a home computer with Broadband, a TV system having access to Internet or a special application, a basic mobile phone, and the like. Further, in one embodiment, the customer 130 places an order by going to a website of the provider 110, calling to the provider 110, faxing to the provider 110, running a special application on the communication device 132, or the like.

In yet another embodiment, the customer 130 does not need a communication device having GPS capabilities, as the customer location is determined via technologies other than the GPS technology (e.g., RF id tags, mobile radio triangulation technology, and the like).

In the embodiment depicted in FIG. 1, the customer 130 places an order for a product of the provider 110 via the communication device 132. The transaction engine 124 processes the order, including a payment transaction. The transaction engine 124 also processes communications between the customer 130 and the provider 110, such as messages sent and received via the communication device 132 (e.g., the customer 130 informing the provider 110 about delay, changes in the pick-up time, and the like).

In one embodiment, the customer 130 pays for the order via a credit card. In another embodiment, the customer 130 has a special account with the provider 110 and that account is charged for an appropriate amount. In yet another embodiment, the customer 130 has a special account with the server-support system 120 and this account is charged for the order. In this manner, a transaction between the provider 110 and the customer 130 debits or credits an account(s) accessed via the server-support system 120.

In one embodiment, the customer 130 optionally selects during the order process a pick-up time and/or the provider's location. In another embodiment, the customer 130 is provided with an interactive menu allowing the customer 130 to select product(s). The menu presents some or all of the products available from the provider 110, products favored by the customer, pre-arranged combination of products or any combination thereof. In yet another embodiment, after the customer 130 chooses the product(s), the order is optionally modified if the provider 110 cannot not complete the order as desired by the customer 130. The customer 130 is optionally provided with alternative pick-up times and/or alternative pick-up locations. It should be understood, that such transactions are performed via the transaction engine 124, or directly with the provider 110, or combination thereof.

The location engine 122 determines customer location and provides the determined location to the provider 110 to the terminal 114. In one embodiment, the location engine sends a request to the communication device 132 for the customer location. The communication device 132 provides a response containing the customer location, which the location engine 122 transfers to the provider. In another embodiment, after the customer 130 has placed an order, the communication device 132 continuously transmits the customer location to the location engine 122. In yet another embodiment, the location engine 122 determines the customer location using triangulation technology.

In one embodiment, the location engine 122 calculates an estimated customer arrival time and transmits the information to the provider 110. Such calculation is based, for example, on the distance between the customer location and the provider location. Additional factors are optionally used in this calculation, such as current traffic situation, time of the day, previous experience with the customer 130, and/or the like.

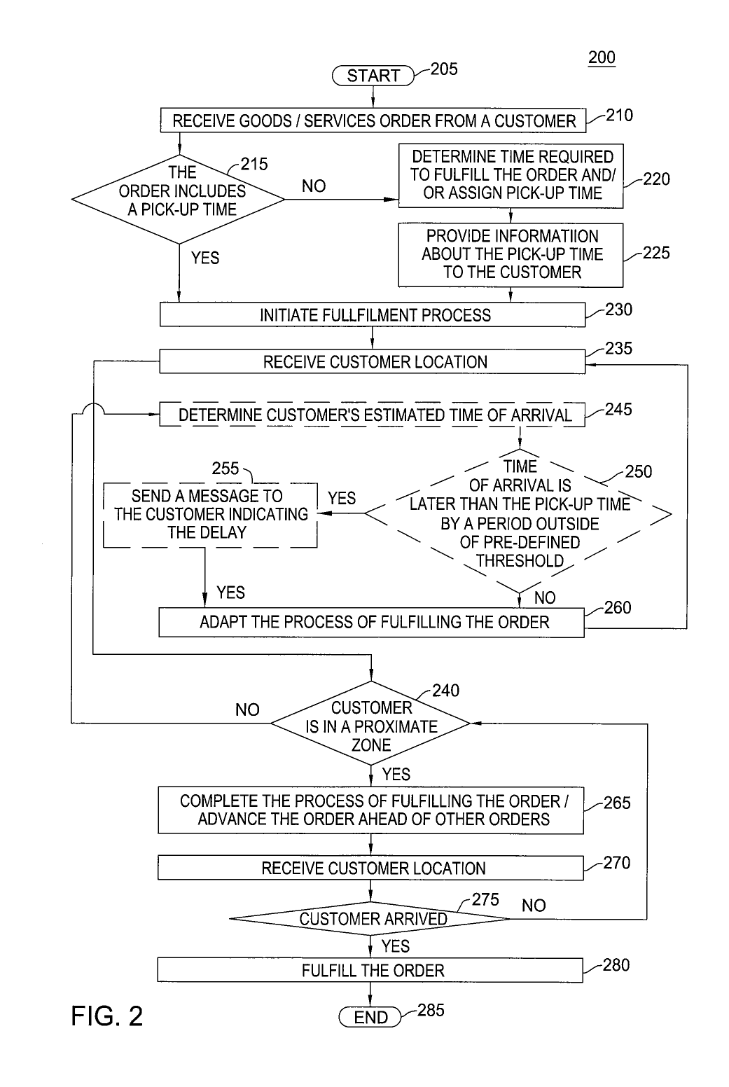

FIG. 2 depicts a flow diagram of a method for providing a service to a customer. The method starts at step 205. At step 210, an order from a customer 130 for at least one product of a provider 110 is received. At step 215, it is determined whether the order includes the pick-up time.

If the order does include the pick-up time, then the method continues with step 230. However, if the order does not include the pick-up time, then at step 220 the time required by the provider to fulfill the order is determined. Then, the customer is assigned the determined time as the pick-up time. In another embodiment, the determined time is only one of the factors considered in determining and assigning the customer pick-up time. Such factors include, but are not limited to, customer preferences (e.g., customer prefers a certain time), provider's expectations of similar orders being placed at approximately the same time (e.g., if the provider expects similar orders to be placed, it may need more or less time to prepare the customer's order), traffic patterns (e.g., rush hour indicates that the customer will be delayed), existing orders in progress (e.g., another customer placed an order for the same product, but was delayed, thus the prepared order is reassigned), and the like.

At step 225, the customer is informed about his/her pick-up time. In one embodiment, the transaction engine 124 or location engine 122 sends a message to the communication device 132 informing the customer 130 about the pick-up time. In another embodiment, the customer 130 receives a call on the communication device 132 or a phone, the phone number of which the customer 130 has previously provided.

At step 230, a fulfillment process 112 is initiated. For example, in one embodiment, the provider 110 determines/identifies the steps necessary to fulfill the order, which employee(s) will perform them, when the fulfillment process 112 should start, and the like. In another embodiment, the step simply includes determining when the fulfillment process 112 should start.

At step 235, the location of the customer 130 is received or calculated. As discussed above, in one embodiment the communication device 132 has a GPS and broadband capabilities. The communication device 132 determines its GPS location and sends the location to the location engine 122. Such determination and/or transmission is optionally initiated and/or requested by the customer 130, the communication device 132, the provider 110, the location engine 122, or/and the transaction engine 124. In another embodiment, the location engine 124 determines the customer location via, for example triangulation method, and then transmits the customer location to the provider 110 on the terminal 114.

At step 240, it is determined, based on the customer location, whether the customer 130 is in a zone proximate the provider 110. The proximate zone is optionally defined as an area within a certain distance from the provider, a certain geographical area, certain sets of geographical areas, an area located within a certain time or range of the customer reaching the provider, and the like. Further, in one embodiment, a proximate zone is the same for every customer and every order. In another embodiment, the proximate zone varies depending on a particular order, e.g., preparing coffee takes less time than preparing chicken, thus the proximate zone for an order of coffee may be smaller/shorter than for an order of chicken. In yet another embodiment, the proximate zone depends on one or more factors, such as the time of day, characteristics or habits of the particular customer, an amount of currently pending orders, a number of the provider's employees currently working, and the like. Furthermore, while in one embodiment the proximate zone is fixed, in another embodiment the proximate zone(s) are modified according to time and other factors.

If the customer 130 is not in the proximate zone, then the method continues with the step 245. If the customer 130 is in the proximate zone, then the method continues with the step 265. At step 265, the provider starts a final portion of the fulfillment process 112 (e.g., boxing ordered products; if the customer 130 ordered lumber, taking the prepared lumber to a loading dock; if the customer 130 ordered food, putting the food out for curb-side pick up; and the like). In another embodiment, the provider 110 advances the customer's order ahead of other pending orders where the customer is arriving sooner than the other customers. In yet another embodiment, if the provider has several pending orders and each customer is in the proximate zone, then those orders (while optionally being advanced over other orders,) are completed in chronological order. In yet another embodiment, the order of completion of the orders is determined based on the time that each customer needs before he/she reaches the provider and the time that is needed to complete their orders.

At step 270, another customer location is received or calculated. At step 275, it is determined whether the customer 130 has arrived, for example by comparing the customer location with the location of the provider 110 or the provider's parking lot. If the customer 130 has arrived, the method continues with the step 280. However, if the customer 130 has not arrived, the method returns to step 240.

It should be noted that even after being in the proximate zone, the customer 130 might leave the proximate zone without reaching the provider 110 (e.g., if the customer merely drove through the proximate zone). Thus, in the embodiment depicted in FIG. 2, the method returns to step 245 if the customer 130 leaves the proximate zone without reaching the provider.

At step 280, the provider 110 completes the fulfillment process 112 for the customer 130. How the process is completed depends, for example, on the kind of product that the customer 130 has ordered. In one embodiment, if the provider 110 is a restaurant, the prepared food is brought to the customer 130, and such action fulfills the order. In another embodiment, if the provider 110 is, for example, a home and garden store, fulfilling the order also includes loading the ordered products into the customer's car. In yet another embodiment, if the provider 110 is a tire service station, the fulfilling the order includes changing tires. The method is completed with step 285, when the customer 130 leaves with the fulfilled order.

At step 245, an estimated customer arrival time is optionally determined. In one embodiment the estimated customer arrival time is provided to the terminal 114 of the provider 110 by the location engine 122. In another embodiment, the provider 110 determines the estimated customer arrival time based on the last received customer location.

At step 250, the determined estimated time of arrival is compared to the customer pick-up time. When the estimated customer arrival time is later than the pick-up time and the difference is significant (e.g., larger than a pre-defined threshold value, such as 10 minutes) then at step 255, the customer 130 is informed about the delay via, illustratively, a message sent from the provider 110 to the communication device 132 via the transaction engine 124.

At step 260, the provider 110 adapts the fulfillment process 112 based on current information, such as the estimated customer arrival time and/or the customer location. In some embodiments, other factors affect the adaptation of the fulfillment process 112, such as the time of day, specifics of a particular customer, amount of currently pending orders, amount of the provider's employees currently working, and the like. In this manner, the provider 110 can efficiently use its resources and assure that the order is prepared on time with respect to the customer arrival time. It should be noted that in some situations, the provider 110 simply does not adapt the fulfillment process 112, such as when the fulfillment process 112 and the customer's arriving schedule are synchronous. After the adaptation (if any) is complete, the method returns to step 235 where another customer location is received.

It should be noted that many of the above-described steps are optionally performed by the provider 110, the location engine 122, the transaction engine 124, or combinations thereof, depending on the provider's needs and resources, costs involved, and the like. For example, step 220 of determining time required to fulfill the order is performed either by the terminal 114 of the provider 110, or by the transaction engine 124, or the like. In one embodiment, the transaction engine 124 has pre-stored information regarding how much time it usually takes the provider 110 to complete an order similar to the order placed by the customer 130. Optionally, such information is initially provided to the transaction engine 124 by the provider 110 and/or accumulated by the transaction engine 124 over time based on processed transactions. Based on such information, the transaction engine 124 assigns the pick-up time to the customer.

It should be noted that it is not necessary to perform all of the above-described steps in the order named. Furthermore, not all of described steps are necessary for the described method to operate. Which steps should be used, in what order the steps should be performed, and whether some steps should be repeated more often than other steps is determined, based on, for example, need of a particular provider. Thus, in some embodiments, the customer location is continuously provided/received or otherwise determined, while in other embodiments this step is done periodically.

Various embodiments are directed to the purchase of transportation services, such as airline, train, ferry, automobile or other transportation services. As an example, a customer orders airline tickets remotely from an airline or other common carrier service provider using any of the transacting methodologies discussed herein. The fulfillment process comprises providing common carrier means (e.g., an airline flight, train ride and the like) having associated with it scheduled departure and arrival times. Ancillary services are typically required, such as ticket/boarding pass print out, security screening and so on. As the customer proceeds to the designated departure point (e.g., an airport, train station or ferry terminal), the location of the customer is determined as discussed above. The determined customer location is used to trigger specific notifications from the carrier indicative of, for example, schedule delays, traffic problems proximate the departure point or between the customer and the departure point, delays associated with security screening procedures and the like.

Generally speaking, customer location information is used to determine which of the many carrier operating details are sufficiently relevant to the customer at the present time to warrant a corresponding customer notification. For example, where a flight is delayed, canceled or experiences a change in departure gate, a customer will likely benefit from notification, irrespective of customer location. Similarly, if a traffic issue arises near the airport, but the customer has already arrived at the airport, customer notification of the traffic issue is not necessary. In addition to customer location, various embodiments utilize customer speed and other parameters to determine whether or not a message should be sent to the customer.

Ancillary services associated with a common carrier may also be adapted in response to scheduling delays, customer location and the like. For example, those customers associated with a delayed flight may be de-prioritized within a security screening process so that other customers may more quickly traverse the screening process (e.g., especially useful where the other customers are themselves running late with respect to their flight).

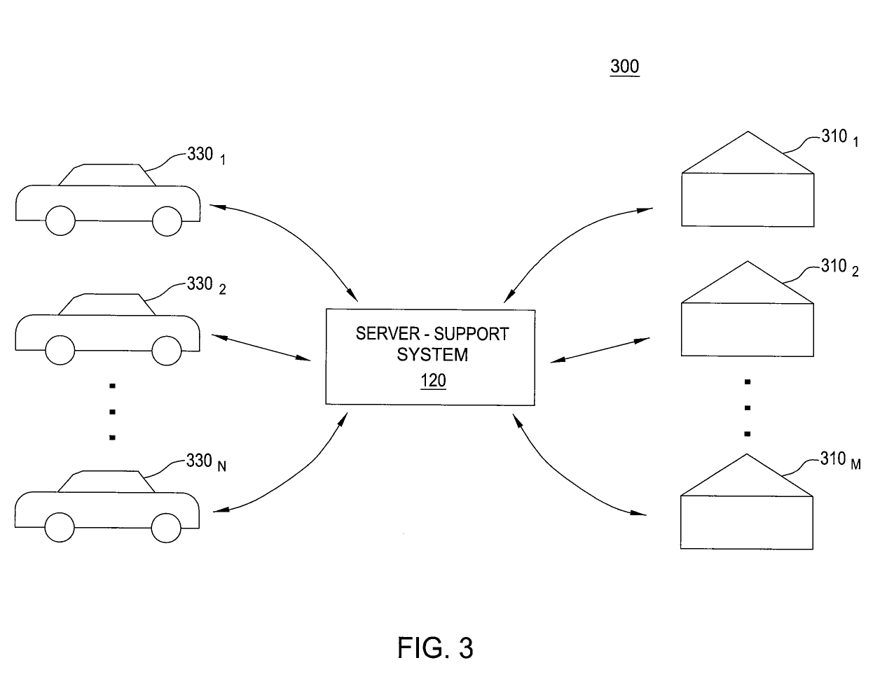

FIG. 3 illustrates a high level diagram of a system 300 for providing a service to one or more customers. A server-support system 120 processes all communications between N customers (denoted as 130₁, 130₂, . . . 130_{N}) and M providers (denoted as 110₁, 110₂, . . . 110_{M}.). Both, the customers 130 and the providers 110 optionally subscribe for a service with the server-support system 120. Thus, in this embodiment each provider 110 and each customer 130 has a service agreement with the server-support system defining their respective rights.

For example, a customer 130ᵢ places an order for goods or services of at least one of the providers, 110ⱼ, via the sever support system 120. The server support system 120 determines whether such order is within the service agreement of the customer 130ᵢ and the provider 110ⱼ. If such an order is not within the service agreement of at least one of the parties, the server-support system 120 informs both parties that the transaction cannot be completed. Alternatively, the server-support system 120 suggests to a party, for whom the order was outside of the service agreement rights, to subscribe for the service. Once the party subscribes, the transaction between the customer 130ᵢ and the provider 110ⱼ will proceed in a usual manner, as it was described above.

In one embodiment, a subscription includes all the providers 110₁ through 110_{M}, individual providers, such as 110ⱼ, or a predefined/selected number of the individual providers 110. Thus, the sever-support system 120 manages both the customers' subscriptions and the providers' subscriptions. In another embodiment, each individual provider 110ⱼ is responsible managing the customers' subscriptions and for providing information regarding such subscriptions to the server support system 120, e.g., when an order is being placed.

As a part of the subscription of the customer 130, the provider 110, or both, the server-supports system 120 allows the customers 130 and the providers 110 to have accounts that they would use in transactions between them, such as placing an order. Such accounts are optionally tied to personal accounts of the customers 130 and/or the providers 110. Alternatively, the customers 130 and/or the providers 110 are billed subsequent to completed transaction(s).

In one embodiment, the server-support system 120 also support accounts of the customers 130 and/or the providers 110 that are replenished as needed. Even if, for example, the customer 130 already has an account with the server-support system 120, he/she can choose alternative payment methods while placing an order, such as via a credit card. In another embodiment, the customer 130 does not need to be subscribed to either the provider 110 or the server-support system 120 to place an order. In yet another embodiment, a particular provider 110 optionally accepts transactions with any customer 130, even if such a customer does not have a subscription. In such a case, the customer 130, for example, temporarily registers his communication device 132 (as a guest) and pays for the placed order with a credit card.

It should be noted that while FIG. 3 depicts the sever-support system 120 as having one facility, in some embodiments, the sever-support system 120 includes more than one facility, for example, at least one central facility and at least one satellite facility located in different geographical locations. Such satellite facilities may manage transactions conducted between certain groups of the customers 130 and the providers 110. The central facility is responsible for coordinating communication between the facilities, customers 130, and the providers 110 and for storing information that is used by either of them.

The above-described embodiments may be implemented within the context of methods, computer readable media, and computer program processes. As such, it is contemplated that some of the steps discussed herein as methods, algorithms, and/or software processes may be implemented within hardware (e.g., circuitry that cooperates with a processor to perform various steps), software or a combination of hardware and software.

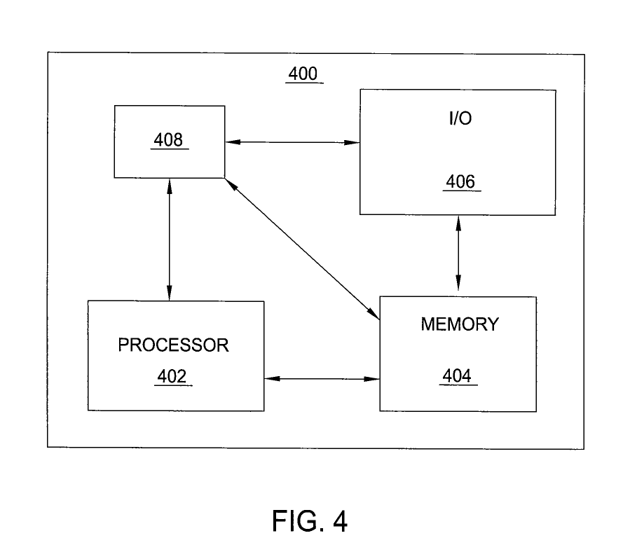

FIG. 4 depicts a high level block diagram of a general purpose computing device 400. In one embodiment, a general purpose computing device 400 comprises a processor 402, a memory 404, a function module 408 and various input/output (I/O) devices 306 such as a monitor, a keyboard, a mouse, a modem, a printer, and the like. In one embodiment, at least one I/O device is a storage device (e.g., a disk drive, an optical disk drive, a floppy disk drive). A person skilled in the art understands that the function module 408 can be implemented as a physical device or subsystem that is coupled to a processor through a communication channel. The function module 408 may comprise software and/or hardware adapted to implement a particular function or functions, such as discussed above with respect to the various method and system components. That is, the general purpose computing device 400 may be adapted for use in any of the functional elements described herein, including the location engine 122, the transaction engine 124, the communication device 132, the terminal 114 and/or the fulfillment process 112.

Alternatively, the function module 408 may be implemented by one or more software applications (or even a combination of software and hardware, e.g., using Application Specific Integrated Circuits (ASIC), Field Programmable Gate Arrays (FPGAs) or Digital Signal Processors (DSPs)), where the software is loaded from a storage medium (e.g., I/O devices 406) and operated by the processor 402 in the memory 404 of the general purpose computing device 400. Thus, in one embodiment, the service module 408 described herein with reference to the other figures can be stored on a computer readable medium or carrier (e.g., RAM, magnetic or optical drive or diskette, and the like), transmitted via a data stream in a signal bearing medium such as a broadcast medium, and/or stored within a working memory or mass storage device associated with the general computing device 400.

The above described embodiments may be implemented within the context of methods, computer readable media, and computer program processes. As such, it is contemplated that some of the steps discussed herein as methods, algorithms, and/or software processes may be implemented within hardware (e.g., memory and input/output circuitry that cooperates with a processor to perform various steps), software or a combination of hardware and software.

One embodiment may be implemented as a computer program product wherein computer instructions, when processed by a computer, adapt the operation of the computer such that the methods and/or techniques described herein are invoked or otherwise provided. Instructions for invoking the methods may be stored in fixed or removable media, transmitted via a data stream in a signal bearing medium such as a broadcast medium, and/or stored within a working memory or mass storage device associated with a computing device operating according to the instructions.

Although various embodiments have been shown and described in detail herein, those skilled in the art can readily devise many other varied embodiments that still incorporate the described teachings.

What is claimed is:

1. A system for providing a service to a customer, comprising:
a transaction engine, for transacting with a customer to receive therefrom an order for at least one product of a provider, and for providing a processed order to the provider; and
a location engine, for providing customer location information to enable thereby an adaptation of a provider order fulfillment process.

2. The system of claim 1, wherein the provider uses customer location information to estimate a customer arrival time and adapt the provider order fulfillment process in response to the determined customer arrival time.

3. The system of claim 1, wherein the location engine estimates a customer arrival time at a provider and communicates the customer arrival time estimate to the provider.

4. The system of claim 1, wherein the location engine determines customer location via a global positioning system (GPS) device associated with a customer.

5. The system of claim 4, wherein the GPS device comprises a GPS-enabled mobile telephone.

6. The system of claim 1, wherein the location engine determines customer location via a mobile network in communication with a mobile telephone associated with a customer.

7. The system of claim 6, wherein the mobile network uses a triangulation technique to determine the location of the mobile telephone associated with a customer.

8. The system of claim 1, wherein the transaction engine is configured to communicate at least one message between the customer and provider.

9. The system of claim 1, wherein the processed order includes a pick-up time.

10. The system of claim 9, wherein:
the location engine communicates customer location information to the transaction engine; and
the transaction engine estimates a customer arrival time and communicates a reminder message to the customer if the estimated customer arrival time is later than a scheduled pick-up time.

11. The system of claim 1, wherein the transaction engine is configured to process a payment for the order.

12. The system of claim 1, wherein the transaction engine is configured to determine whether the order can be completed by the provider as requested by the customer.

13. The system of claim 1, wherein the provider communicates order status to the customer via the transaction engine.

14. A method for providing a service to a customer, comprising:
receiving an order from the customer;
initiating an order fulfillment process;
receiving customer location information; and
adapting the order fulfillment process in response to the customer location information.

15. The method of claim 14, wherein the customer location information is determined using data provided by a global position system (GPS) device associated with the customer.

16. The method of claim 14, further comprising:
determining a pick-up time associated with the order.

17. The method of claim 16, further comprising:
estimating a customer arrival time using the customer location information;
comparing the estimated customer arrival time to the pick-up time; and
providing a message to the customer if the estimated customer arrival time is later than the pick-up time by more than a threshold delay value.

18. The method of claim 16, wherein the pick-up time has been selected by the customer.

19. The method of claim 14, further comprising:
initiating a final portion of the order fulfillment process if the customer is within a zone proximate the provider.

20. The method of claim 19, further comprising:
completing the order fulfillment process if the customer location information shows that the customer has arrived.

21. The method of claim 19, further comprising:
estimating a customer arrival time using the customer location information;
determining whether the order fulfillment process could be completed before the estimated customer arrival time; and
prioritizing the order fulfillment process if the order fulfillment process cannot be completed before the estimated customer arrival time.

22. A system for providing a service to one or more customers, comprising:
a server-support system; and
one or more providers in communication with the server-support system, wherein the server-support system provides customer location information to the one or more provider regarding the one or more customers, in response to receiving at least one order for the one or more provider.

23. The system of claim 22, wherein the one or more customers are subscribed for the service.

24. The system of claim 23, wherein the server-support system manages at least one account for at least one customer for using to place an order with the one or more providers.

25. The system of claim 22, wherein the one or more providers are subscribed for providing the service to the one or more customers.

26. The system of claim 22, wherein the server-support system determines customer location via a global positioning system (GPS) device associated with the one or more customer.

27. The system of claim 26, wherein the GPS device comprises a GPS enabled mobile phone.
